(19) United States
(12) Patent Application Publication
(10) Pub. No.: US 2023/0306247 A1
(43) Pub. Date: Sep. 28, 2023

(54) NEURON CIRCUIT AND NEURAL PROCESSOR INCUDING NEURON CIRCUITS

(71) Applicant: Electronics and Telecommunications Research Institute, Daejeon (KR)

(72) Inventors: In San JEON, Daejeon (KR); Hyuk KIM, Daejeon (KR); Jae-Jin LEE, Daejeon (KR); Tae Wook KANG, Daejeon (KR); Sung Eun KIM, Daejeon (KR); Young Hwan BAE, Daejeon (KR); Kyung Jin BYUN, Daejeon (KR); Kwang IL OH, Daejeon (KR)

(73) Assignee: Electronics and Telecommunications Research Institute, Daejeon (KR)

(21) Appl. No.: 18/073,830

(22) Filed: Dec. 2, 2022

(30) Foreign Application Priority Data
Mar. 25, 2022 (KR) 10-2022-0037614

(51) Int. Cl. G06N 3/063; G06N 3/049

(52) U.S. Cl. CPC G06N 3/063; G06N 3/049

(57) ABSTRACT

Disclosed is a neuron circuit, which includes a first bias circuit that adds a bias current to an input current to generate a biased input current, a logarithm-based neuron calculation circuit that performs a logarithm calculation on an amount of current of the biased input current to generate an input logarithm value and generates a biased output voltage by performing a logarithm-based Hodgkin-Huxley model calculation based on the input logarithm value, and a second bias circuit that adds a bias voltage to the biased output voltage to generate an output voltage.

### CROSS-REFERENCE TO RELATED APPLICATIONS

This application claims priority under 35 U.S.C. § 119 to Korean Patent Application No. 10-2022-0037614, filed on Mar. 25, 2022, in the Korean Intellectual Property Office, the disclosures of which are incorporated by reference herein in their entireties.

### BACKGROUND

Embodiments of the present disclosure described herein relate to an electronic device, and more particularly, relate to a neuron circuit for performing neural processing and a neural processor including the neuron circuits.

Various neuron models are being studied in the fields of neuroscience and artificial intelligence. However, the neuron models studied in the field of artificial intelligence use abstract models to reduce computational complexity. Therefore, the neuron models studied in the field of artificial intelligence have low biological relevance. The neuron models studied in the field of neuroscience can reproduce various waveforms by focusing on forming spike waveforms. However, the waveforms of neuronal models studied in the field of neuroscience have low connectivity with biological neurons.

Among neuronal models, a Hodgkin-Huxley Model (HHM) has relatively high biological relevance. However, the HHM has disadvantage of high computational complexity compared to other neuron models.

### SUMMARY

Embodiments of the present disclosure provide a neuron circuit with reduced computational complexity and a neural processor including the neuron circuits.

According to an embodiment of the present disclosure, a neuron circuit includes a first bias circuit that adds a bias current to an input current to generate a biased input current, a logarithm-based neuron calculation circuit that performs a logarithm calculation on an amount of current of the biased input current to generate an input logarithm value and generates a biased output voltage by performing a logarithm-based Hodgkin-Huxley model calculation based on the input logarithm value, and a second bias circuit that adds a bias voltage to the biased output voltage to generate an output voltage.

According to an embodiment, the bias current may be set such that the biased input current corresponds to a positive value even when the input current corresponds to a negative value.

According to an embodiment, the bias current may be about 10 uA.

According to an embodiment, the bias voltage may be about 96 mV.

According to an embodiment, the logarithm-based neuron calculation circuit may include: a first primary calculator that generates a first parameter based on an exponential logarithm value of the biased output voltage of a previous cycle and an inversion value of the biased output voltage of the previous cycle; a second primary calculator that generates a second parameter based on the inversion value of the biased output voltage of the previous cycle; a third primary calculator that generates a third parameter based on the exponential logarithm value of the biased output voltage of the previous cycle and the inversion value of the biased output voltage of the previous cycle; a fourth primary calculator that generates a fourth parameter based on the inversion value of the biased output voltage of the previous cycle; a fifth primary calculator that generates a fifth parameter based on the inversion value of the biased output voltage of the previous cycle; and a sixth primary calculator that generates a sixth parameter based on the inversion value of the biased output voltage of the previous cycle.

According to an embodiment, the first primary calculator may include: a first multiplexer including a first input to which a value of about ‘ln 41’ is input and a second input to which the exponential logarithm value of the biased output voltage of the previous cycle is input; a second multiplexer including a first input to which the exponential logarithm value of the biased output voltage of the previous cycle is input and a second input to which the value of about ‘ln 41’ is input; a first subtractor that subtracts a value of the biased output voltage from a value of about ‘41’; a multiplier that multiplies an output of the first subtractor by a value of about ‘0.1’; a third multiplexer including a first input to which an output of the multiplier is input and a second input to which a value of about ‘0’ is input; a fourth multiplexer including a first input to which the value of about ‘0’ is input and a second input to which an output of the multiplier is input; a selection circuit that controls the first to fourth multiplexers such that first inputs are connected to outputs when the exponential logarithm value of the biased output voltage of the previous cycle is greater than the value of about ‘ln 41’, and second inputs are connected to the outputs when the exponential logarithm value of the biased output voltage of the previous cycle is not greater than the value of about ‘ln 41’; a first Jacobian subtractor including a first input to which an output of the first multiplexer is input and a second input to which an output of the second multiplexer is input, and that performs a Jacobian subtraction on a value of the first input and a value of the second input; a second Jacobian subtractor including a first input to which an output of the third multiplexer is input and a second input to which an output of the fourth multiplexer is input, and that performs the Jacobian subtraction on a value of the first input and a value of the second input; a second subtractor that subtracts an output of the second Jacobian subtractor from an output of the first Jacobian subtractor; and an adder that adds a value of about ‘ln 0.01’ to an output of the subtractor and outputs the added result as the first parameter, and the Jacobian subtraction may include: when the value of the first input of the first Jacobian subtractor or the second Jacobian subtractor is greater than the value of the second input, calculating an exponential logarithm of a value obtained by subtracting an exponential power of the value of the second input from an exponential power of the value of the first input; when the value of the first input of the first Jacobian subtractor or the second Jacobian subtractor is not greater than the value of the second input, calculating an exponential logarithm of a value obtained by subtracting the exponential power of the value of the first input from the exponential power of the value of the second input; when the value of the first input of the first Jacobian subtractor or the second Jacobian subtractor is equal to or greater than the value of the second input, calculating a positive sign; and when the value of the first input of the first Jacobian subtractor or the second Jacobian subtractor is less than the value of the second input, calculating a negative sign.

According to an embodiment, the second primary calculator may include: an adder that adds a value of about ‘31’ to the inversion value of the biased output voltage of the previous cycle; and a subtractor that subtracts a value of about ‘ln 8’ from an output of the adder and outputs the subtracted result as the second parameter.

According to an embodiment, the third primary calculator may include: a first multiplexer including a first input to which a value of about ‘ln 56’ is input and a second input to which the exponential logarithm value of the biased output voltage of the previous cycle is input; a second multiplexer including a first input to which the exponential logarithm value of the biased output voltage of the previous cycle is input and a second input to which the value of about ‘ln 56’ is input; a first subtractor that subtracts a value of the biased output voltage from a value of about ‘56’; a multiplier that multiplies the output of the first subtractor by a value of about ‘0.1’; a third multiplexer including a first input to which an output of the multiplier is input and a second input to which a value of about ‘0’ is input; a fourth multiplexer including a first input to which the value of about ‘0’ is input and a second input to which the output of the multiplier is input; a selection circuit that controls the first to fourth multiplexers such that first inputs are connected to outputs when the exponential logarithm value of the biased output voltage of the previous cycle is greater than a value of about ‘ln 56’, and second inputs are connected to the outputs when the exponential logarithm value of the biased output voltage of the previous cycle is not greater than the value of about ‘ln 56’; a first Jacobian subtractor including a first input to which an output of the first multiplexer is input and a second input to which an output of the second multiplexer is input, and that performs a Jacobian subtraction on a value of the first input and a value of the second input; a second Jacobian subtractor including a first input to which an output of the third multiplexer is input and a second input to which an output of the fourth multiplexer is input, and that performs the Jacobian subtraction on a value of the first input and a value of the second input; a second subtractor that subtracts an output of the second Jacobian subtractor from an output of the first Jacobian subtractor; and an adder that adds a value of about ‘ln 0.1’ to an output of the subtractor and outputs the added result as the third parameter.

According to an embodiment, the fourth primary calculator may include: a first adder that adds a value of about ‘31’ to the inversion value of the biased output voltage of the previous cycle; a multiplier that multiplies the output of the first adder by a value of about ‘ 1/18’ or a value of about ‘0.0556’; and a second adder that adds a value of about ‘ln 4’ to an output of the multiplier and outputs the added result as the fourth parameter.

According to an embodiment, the fifth primary calculator may include: a first adder that adds a value of about ‘31’ to the inversion value of the biased output voltage of the previous cycle; a multiplier that multiplies the output of the first adder by a value of about ‘0.05’; and a second adder that adds a value of about ‘ln 0.07’ to an output of the multiplier and outputs the added result as the fifth parameter.

According to an embodiment, the sixth primary calculator may include: a first adder that adds a value of about ‘61’ to the inversion value of the biased output voltage of the previous cycle; a first multiplier that multiplies an output of the first adder by a value of about ‘0.1’; a Jacobian adder including a first input to which an output of the first multiplexer is input and a second input to which a value of about ‘ln 4’ is input, and that performs a Jacobian addition on a value of the first input and a value of the second input; and a second multiplier that multiplies an output of the Jacobian adder by a value of about ‘−1’ and to output the multiplied result as the sixth parameter, and the Jacobian addition includes calculating an exponential logarithm of a sum of an exponential power of the value of the first input and an exponential power of the value of the second input of the Jacobian adder.

According to an embodiment, the neuron circuit may further include: a first secondary calculator including a first parameter input to which the first parameter is input, a second parameter input to which the second parameter is input, and a parameter output to which a seventh parameter is output, and that calculates the seventh parameter of a current cycle based on the first parameter, the second parameter, an initial value of the seventh parameter, and an exponential logarithm value of a time difference between the previous cycle and the current cycle; a second secondary calculator including a first parameter input to which the third parameter is input, a second parameter input to which the fourth parameter is input, and a parameter output to which an eighth parameter is output, and that calculates the eighth parameter of the current cycle based on the third parameter, the fourth parameter, an initial value of the eighth parameter, and the exponential logarithm value of the time difference; and a third secondary calculator including a first parameter input to which the fifth parameter is input, a second parameter input to which the sixth parameter is input, and a parameter output to which a ninth parameter is output, and that calculates the ninth parameter of the current cycle based on the fifth parameter, the sixth parameter, an initial value of the ninth parameter, and the exponential logarithm value of the time difference.

According to an embodiment, each of the first to third secondary calculators may include: a first Jacobian subtractor including a first input to which a value of ‘0’ is input and a second input to which a value of the parameter output of the previous cycle is input, and that performs a Jacobian subtraction on a value of the first input and a value of the second input; a first adder that adds a value of the first parameter input and an output of the first Jacobian subtractor; a second adder that adds a value of the second parameter input and a value of the parameter output of the previous cycle; a first multiplexer including a first input to which an output of the first adder is input and a second input to which an output of the second adder is input; a second multiplexer including a first input to which the output of the second adder is input and a second input to which the output of the first adder is input; a second Jacobian subtractor including a first input to which an output of the first multiplexer is input and a second input to which an output of the second multiplexer is input, and that performs the Jacobian subtraction on a value of the first input and a value of the second input; a third adder that adds the exponential logarithm value of the time difference to an output of the second Jacobian subtractor; a Jacobian adder that performs a Jacobian addition on an output of the third adder and a value of the parameter output of the previous cycle; a third Jacobian subtractor including a first input to which an output of the third adder is input and a second input to which the value of the parameter output of the previous cycle is input, and that performs a third Jacobian subtraction on a value of the first input and a value of the second input; a third multiplexer including a first input to which an output of the Jacobian adder is input and a second input to which an output of the third Jacobian subtractor is input; a selection circuit that allows the first to third multiplexers to output values of first inputs when an output of the first adder is greater than an output of the second adder, and that allows the first to third multiplexers to output values of second inputs when the output of the first adder is not greater than the output of the second adder; and a change amount calculator that calculates an amount of change corresponding to the exponential logarithm value of the time difference based on an output of the third multiplexer and a corresponding initial value among initial values of the seventh to ninth parameters, and that adds the amount of change to the initial value and outputs the added result as a corresponding parameter among the seventh to ninth parameters.

According to an embodiment, the neuron circuit may further include: an input calculator that generates a tenth parameter and an eleventh parameter based on the seventh to ninth parameters, the exponential logarithm value of the biased output voltage of the previous cycle, and a biased input current; a tertiary calculator that generates an exponential logarithm value of the biased output voltage of the current cycle, based on the tenth parameter, the eleventh parameter, an exponential logarithm value of an initial value of the biased output voltage, and the exponential logarithm value of the time difference; and an output calculator that generates the biased output voltage of the current cycle and an inversion value of the biased output voltage of the current cycle, based on the exponential logarithm value of the biased output voltage of the current cycle.

According to an embodiment, the input calculator may include: a first Jacobian subtractor including a first input to which the exponential logarithm value of the biased output voltage of the previous cycle is input and a second input to which an exponential logarithm value of a potassium reversal potential is input, and that performs a Jacobian subtraction on a value of the first input and a value of the second input; a first multiplier that multiplies the seventh parameter by a value of ‘4’; a first adder that add an output of the first Jacobian subtractor, an output of the first multiplier, and an exponential logarithm value of potassium conductance per area; a second adder that adds the exponential logarithm value of the biased output voltage of the previous cycle and an exponential logarithm value of leakage conductance per area; a first Jacobian adder that performs a Jacobian addition on an output of the second adder and an exponential logarithm value of a value of the bias current; a third adder that adds the exponential logarithm value of the leakage conductance per area and an exponential logarithm value of a leakage reversal potential; a second Jacobian subtractor including a first input to which an output of the first Jacobian adder is input and a second input to which an output of the third adder is input, and that performs the Jacobian subtraction on a value of the first input and a value of the second input and outputs the performed result as the tenth parameter; a third Jacobian subtractor including a first input to which an output of the first adder is input and a second input to which an output of the second Jacobian subtractor is input, and that performs the Jacobian subtraction on a value of the first input and a value of the second input; a second multiplier that multiplies the eighth parameter by a value of ‘3’; a fourth adder that adds an output of the second multiplier and the ninth parameter; a fourth Jacobian subtractor including a first input to which the exponential logarithm value of the biased output voltage of the previous cycle is input and a second input to which the exponential logarithm value of the potassium reversal potential is input, and that performs the Jacobian subtraction on a value of the first input and a value of the second input; a fifth adder that adds an output of the fourth Jacobian subtractor, an exponential logarithm value of sodium conductance per area, and an output of the fourth adder; an exponential logarithm calculator that calculates an exponential logarithm value of a value of the biased input current; and a second Jacobian adder that performs the Jacobian addition on an output of the fifth adder and an output of the exponential logarithm calculator, and outputs the added result as the eleventh parameter.

According to an embodiment, the tertiary calculator may include: a first multiplexer including a first input to which the tenth parameter is input and a second input to which the eleventh parameter is input; a second multiplexer including a first input to which the eleventh parameter is input and a second input to which the tenth parameter is input; a first Jacobian subtractor including a first input to which an output of the first multiplexer is input and a second input to which an output of the second multiplexer is input, and that performs a Jacobian subtraction on a value of the first input and a value of the second input; a subtractor that subtracts an exponential logarithm value of a membrane capacitance per area from an output of the first Jacobian subtractor; an adder that adds the exponential logarithm value of the time difference to an output of the subtractor; a Jacobian adder that performs a Jacobian addition on an output of the adder and the exponential logarithm value of the biased output voltage of the previous cycle; a second Jacobian subtractor including a first input to which an output of the adder is input and a second input to which the exponential logarithm value of the biased output voltage of the previous cycle is input, and that performs a Jacobian subtraction on a value of the first input and a value of the second input; a third multiplexer including a first input to which an output of the Jacobian adder is input and a second input to which an output of the second Jacobian subtractor is input; a selection circuit that controls the first to third multiplexer such that values of first inputs are output when the tenth parameter is greater than or equal to the eleventh parameter and values of second inputs are output when the tenth parameter is less than the eleventh parameter; and a change amount calculator that calculates an exponential logarithm value of the biased output voltage of the current cycle, based on an output of the third multiplexer and an exponential logarithm value of an initial value of the biased output voltage.

According to an embodiment, the output calculator may include: an exponential calculator that calculates an exponential power of an exponential logarithm value of the biased output voltage of the current cycle and outputs the calculated result as the biased output voltage; and a multiplier that multiplies the value of the biased output voltage by a value of ‘−1’ and outputs the multiplied result as the inversion value of the biased output voltage.

According to an embodiment of the present disclosure, a neural processor includes a plurality of neuron circuits, the plurality of neuron circuits are configured to perform a spiking neural network (SNN) operation, and each of the plurality of neuron circuits includes: a first bias circuit that adds a bias current to an input current to generate a biased input current, a logarithm-based neuron calculation circuit that performs a logarithm calculation on an amount of current of the biased input current to generate an input logarithm value and generates a biased output voltage by performing a logarithm-based Hodgkin-Huxley model calculation based on the input logarithm value, and a second bias circuit that adds a bias voltage to the biased output voltage to generate an output voltage.

According to an embodiment, the bias current may be about 10 uA, and the bias voltage may be about 96 mV.

### BRIEF DESCRIPTION OF THE FIGURES

The above and other objects and features of the present disclosure will become apparent by describing in detail embodiments thereof with reference to the accompanying drawings.

FIG. 1 is a block diagram illustrating an electronic device, according to an embodiment of the present disclosure.

FIG. 2 is a diagram illustrating a neural network, according to an embodiment of the present disclosure.

FIG. 3 is a diagram illustrating a neuron circuit, according to an embodiment of the present disclosure.

FIG. 4 is a diagram illustrating an example of an operation method of a neuron circuit.

FIG. 5 is a diagram illustrating an example of a logarithm-based neuron calculation circuit.

FIG. 6 is a diagram illustrating an example of a first primary calculator.

FIG. 7 is a diagram illustrating an example of a second primary calculator.

FIG. 8 is a diagram illustrating an example of a third primary calculator.

FIG. 9 is a diagram illustrating an example of a fourth primary calculator.

FIG. 10 is a diagram illustrating an example of a fifth primary calculator.

FIG. 11 is a diagram illustrating an example of a sixth primary calculator.

FIG. 12 is a diagram illustrating an example of a secondary calculator of any one of first to third secondary calculators.

FIG. 13 is a diagram illustrating an example of an input calculator.

FIG. 14 is a diagram illustrating an example of a tertiary calculator.

FIG. 15 is a diagram illustrating an example of an output calculator.

### DETAILED DESCRIPTION

Hereinafter, embodiments of the present disclosure will be described in detail and clearly to such an extent that an ordinary one in the art easily implements the present disclosure.

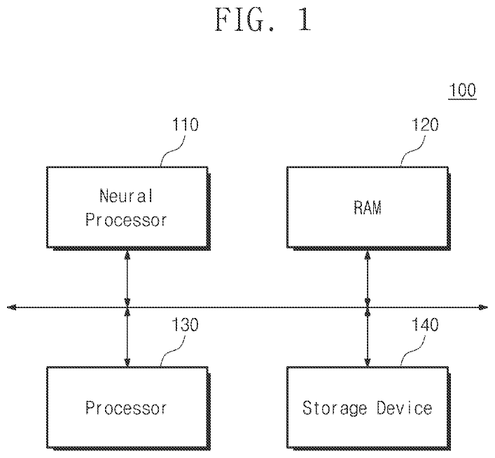

FIG. 1 illustrates a block diagram of an electronic device 10 according to an embodiment of the present disclosure. Referring to FIG. 1, the electronic device 10 may include a neural processor 110 (or a neural processing unit), a random access memory (RAM) 120, a processor 130, and a storage device 140.

The neural processor 110 may perform an inference operation based on various neural network algorithms under a control of the processor 130. For example, the neural processor 110 may perform various operations based on a spiking neural network (SNN). The neural processor 110 may include neuron circuits for processing operations based on a neural network. The neuron circuits may be implemented based on a Hodgkin-Huxley Model (HHM).

The RAM 120 may store data to be processed by the neural processor 110 or the processor 130, various program codes or instructions that may be executed by the neural processor 110 or the processor 130, or data processed by the neural processor 110 or the processor 130. The RAM 120 may include a static random access memory (SRAM) or a dynamic random access memory (DRAM).

The processor 130 may perform various operations necessary for operations of the electronic device 10. For example, the processor 130 may execute firmware, software, or program codes loaded onto the RAM 120. The processor 130 may control the electronic device 10 by executing firmware, software, or program codes loaded onto the RAM 120. The processor 130 may store the results of the executions in the RAM 120 or the storage device 140.

The storage device 140 may store data or information necessary for performing an operation in the neural processor 110 or the processor 130. The storage device 140 may store data processed by the neural processor 110 or the processor 130. The storage device 140 may store software, firmware, program codes, or instructions that may be executed by the neural processor 110 or the processor 130. The storage device 140 may be a volatile memory such as a DRAM or an SRAM or a nonvolatile memory such as a flash memory.

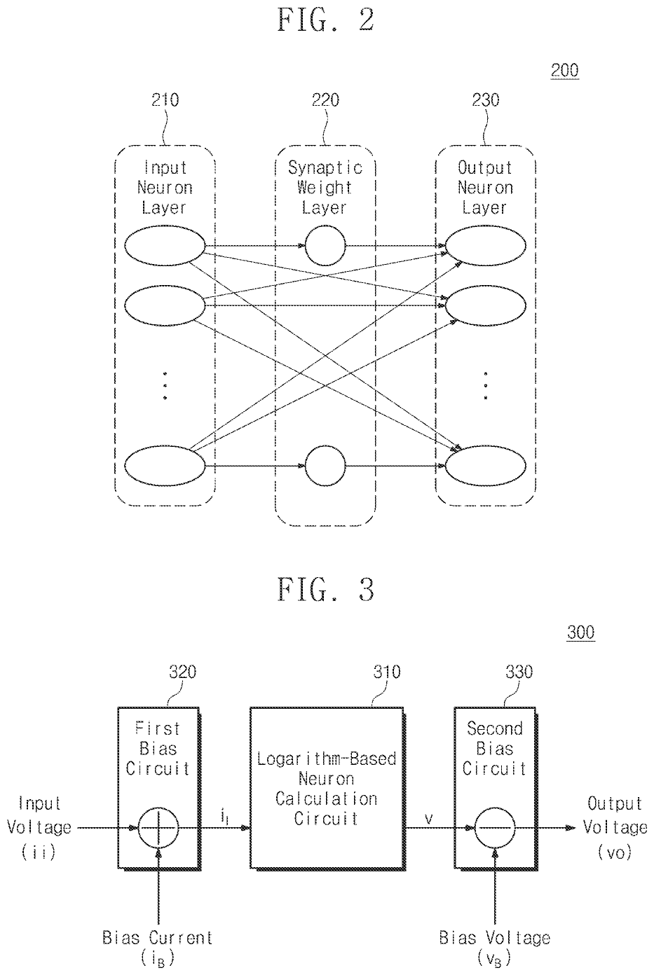

FIG. 2 illustrates a neural network 200 according to an embodiment of the present disclosure. The neural network 200 may be implemented by the neural processor 110. Referring to FIGS. 1 and 2, the neural network 200 may be a spiking neural network.

The neural network 200 may include an input neuron layer 210, a synaptic weight layer 220, and an output neuron layer 230. The neural processor 110 may perform neural network operations based on input subjects (or input data) and may generate output data based on a result of the execution.

The input neuron layer 210 may include one or more input neurons, and the output neuron layer 230 may include one or more output neurons. The synaptic weight layer 220 may include synaptic weights that may determine a connection strength between the input neurons and the output neurons. One input neuron may be connected to all output neurons through a synapse. The input neuron may transfer a spike signal to the output neurons, respectively, based on a value of the corresponding synaptic weight.

Each of the input neurons or the output neurons may include a neuron circuit. The neuron circuit may generate or transfer a spike signal based on the HHM. To reduce computational complexity or amount of computation, the neuron circuits may generate or transfer the spike signal on a logarithm basis and a bias basis.

FIG. 3 illustrates a neuron circuit 300 according to an embodiment of the present disclosure. Referring to FIG. 3, the neuron circuit 300 may generate or transfer a spike signal. The neuron circuit 300 may include a logarithm-based neuron calculation circuit 310, a first bias circuit 320, and a second bias circuit 330.

The logarithm-based neuron calculation circuit 310 may be implemented based on the HMM. The HMM is implemented to operate on a logarithm basis, thereby reducing computational complexity. The logarithm-based neuron calculation circuit 310 may generate a biased output current ‘v’ from a biased input current i_{I}.

The first bias circuit 320 may generate the biased input current i_{I} by adding a bias current i_{B} to an input current ii. The first bias circuit 320 may add the bias current I_{B} to the input current ii such that the logarithm-based neuron calculation circuit 310 normally operates to generate the biased input current i_{I} that falls within a positive range. The bias current I_{B} may be about 10 uA.

The second bias circuit 330 may generate an output voltage ‘vo’ by subtracting a bias voltage v_{B} from the biased output voltage ‘v’. The second bias circuit 330 may remove the bias by reverse-biasing the biased voltage ‘v’. The bias voltage v_{B} may be 96 mV.

Hereinafter, equations for the implementation of the logarithm-based neuron calculation circuit 310 are defined. Referring to the prior art document 1, a neuron model of the HMM may be defined by Equation 1.

$$dv / dt = ( {i}_{I} - {i}_{Na} - {i}_{K} - {i}_{L} ) / {c}_{M} \\ {i}_{K} = {g}_{K} {n}^{4} ( v - {v}_{K} ) \\ {i}_{Na} = {g}_{Na} {m}^{3} h ( v - {v}_{Na} ) \\ {i}_{L} = {g}_{L} ( v - {v}_{L} ) \\ dx / dt = {α}_{x} ( 1 - x ) - {β}_{x} x ( \text{?} , x = n , m , h ) \\ {α}_{n} ( v ) = 0.01 ( v + 10 ) / [ {e}^{( u + 10 ) / 10} - 1 ] \\ {β}_{n} ( v ) = 0.125 {e}^{v / 50} \\ {α}_{m} ( v ) = 0.1 ( v + 25 ) / [ {e}^{( v + 25 ) / 10} - 1 ] \\ {β}_{m} ( v ) = 4 {e}^{v / 18} \\ {α}_{h} ( v ) = 0.07 {e}^{v / 20} \\ {β}_{h} ( v ) = 1 / [ {e}^{( v + 30 ) / 10} + 1 \\ \text{?} \text{indicates text missing or illegible when filed} \qquad [ Equation 1 ]$$

Referring to the prior art document 2, the HMM model of Equation 1 may be changed to Equation 2 by rearranging the notation.

$$dv / dt = ( {i}_{I} - {i}_{Na} - {i}_{K} - {i}_{L} ) / {c}_{M} \\ {α}_{n} ( v ) = 0.01 ( 10 - v ) / [ {e}^{( 10 - v ) / 10} - 1 ] \\ {β}_{n} ( v ) = 0.125 {e}^{- v / 20} \\ {α}_{m} ( v ) = 0.1 ( 25 - v ) / [ {e}^{( 25 - v ) / 10} - 1 ] \\ {β}_{m} ( v ) = 4 {e}^{- v / 18} \\ {α}_{h} ( v ) = 0.07 {e}^{- v / 20} \\ {β}_{h} ( v ) = 1 / [ {e}^{( 30 - v ) / 10} + 1 ] \qquad [ Equation 2 ]$$

Referring to the prior art document 3, by defining the resting voltage of the neuron as −64 mV, Equation 2 may be changed to Equation 3.

$$dv / dt = ( {i}_{I} - {i}_{Na} - {i}_{K} - {i}_{L} ) / {c}_{M} \\ {α}_{n} ( v ) = 0.01 ( v + 55 ) / [ 1 - {e}^{- ( v + 55 ) / 10} ] \\ {β}_{n} ( v ) = 0.125 {e}^{- ( v + 65 ) / 80} \\ {α}_{m} ( v ) = 0.1 ( v + 40 ) / [ 1 - {e}^{- ( v + 40 ) / 10} ] \\ {β}_{m} ( v ) = 4 {e}^{- ( v + 65 ) / 18} \\ {α}_{h} ( v ) = 0.07 {e}^{- ( v + 65 ) / 20} \\ {β}_{h} ( v ) = 1 / [ 1 + {e}^{- ( v + 35 ) / 10} ] \qquad [ Equation 3 ]$$

As shown in FIG. 3, when the input current ii is biased by the bias current I_{B}, the effect of the bias current I_{B} is also reflected in Equation 3, so that Equation 3 may be changed to Equation 4.

$$dv / dt = ( {i}_{I} - {i}_{Na} - {i}_{K} - {i}_{L} ) / {c}_{M} \\ {i}_{K} = {g}_{K} {n}^{4} ( v - {v}_{K} ) \\ {i}_{Na} = {g}_{Na} {m}^{3} h ( v - {v}_{Na} ) \\ {i}_{L} = {g}_{L} ( v - {v}_{L} ) + {i}_{B} \\ dx / dt = {α}_{x} ( 1 - x ) - {β}_{x} x ( \text{?} , x = n , m , h ) \\ {α}_{n} ( v ) = 0.01 ( - v + {v}_{B} - 55 ) / [ {e}^{( - v + {v}_{B} - 55 ) / 10} - 1 ] \\ {β}_{n} ( v ) = 0.125 {e}^{( - v + {v}_{B} - 65 ) / 80} \\ {α}_{m} ( v ) = 0.1 ( - v + {v}_{B} + 40 ) / [ {e}^{( - v + {v}_{B} - 40 ) / 10} - 1 ] \\ {β}_{m} ( v ) = 4 {e}^{( - v + {v}_{B} - 65 ) / 18} \\ {α}_{h} ( v ) = 0.07 {e}^{( - v + {v}_{B} - 65 ) / 20} \\ {β}_{h} ( v ) = 1 / [ {e}^{( - v + {v}_{B} - 35 ) / 10} + 1 ] \qquad [ Equation 4 ]$$

$$\text{?} \text{indicates text missing or illegible when filed}$$

In Equation 4, the membrane capacitance cm per unit area may be 1.0. The potassium conductance g_{K} per unit area may be 36.0. The sodium conductance g_{Na} per unit area may be 120.0. The leakage conductance g_{L} per unit area may be 0.3. The potassium reversal potential v_{K} may be 19. The sodium reversal potential v_{Na} may be 146. The leakage reversal potential v_{L} may be 41.613.

The values of Equation 4 are real number values and may be represented by lowercase letters. When Equation 4 is converted into a logarithm domain, Equation 4 may be changed to Equation 5.

$$V ( t + Δ T ) = V ( t ) ( {[ dV / dt ]}_{M} + Δ T ) for [ dV / dt ] \text{?} ≧ 0 \qquad [ Equation 5 ]$$

$$V ( t ) ( {[ dV / dt ]}_{M} + Δ T ) for [ dV / dt ] \text{?} < 0 \\ dV / dt = ( [ dV / dt ] {\text{?} [ dV / dt ]}_{M} ) \\ [ dV / dt ] \text{?} = + 1 , {[ dV / dt ]}_{M} = {I}_{P} {I}_{N} - {C}_{M} for {I}_{P} ≧ {I}_{N} \\ [ dV / dt ] \text{?} = + 1 , {[ dV / dt ]}_{M} = {I}_{N} {I}_{P} - {C}_{M} for {I}_{P} < {I}_{N} , \\ {I}_{P} = ( {I}_{K} I \text{?} ) , {I}_{N} = I \text{?} ( - {I}_{Na} ) , \\ {I}_{K} = ln ( 36 ) + 4 N + ( V ln ( 19 ) ) \\ - {I}_{Na} = ln ( 120 ) + 3 M + H + ( ln ( 146 ) V ) ( where ( - {I}_{Na} ) \geq 0 ) \\ {I}_{L} = ( ( ln ( 0.3 ) + V ) I \text{?} ln ( 0.3 ) + {V}_{L} ) \\ \begin{matrix}X ( t + Δ T ) = X ( t ) ( {[ dX / dt ]}_{M} + Δ T ) for [ dX / dt ] \text{?} ≧ 0 \\ = X ( t ) ( {[ dX / dt ]}_{M} + Δ T ) for [ dX / dt ] \text{?} < 0\end{matrix} \\ dX / dt = ( [ dX / dt ] {\text{?} [ dX / dt ]}_{M} ) ( where X = N , M , H ) \\ [ dX / dt ] \text{?} = + 1 , {[ dX / dt ]}_{M} = {A}_{0} {B}_{0} for {A}_{0} ≧ {B}_{0} \\ [ dX / dt ] \text{?} = - 1 , {[ dX / dt ]}_{M} = {B}_{0} {A}_{0} for {A}_{0} < {B}_{0} \\ {A}_{0} = ( {A}_{X} + ( 0 X ) ) , {B}_{0} = ( {B}_{X} + X ) \\ {A}_{N} ( V ) = ln ( 0.01 ) + ( ln ( 41 ) V ) = [ ( 0.1 ( 41 - {e}^{V} ) ) ln ( 1 ) ] for V < ln ( 41 ) \\ ln ( 0.01 ) + ( V ln ( 41 ) ) - [ ln ( 1 ) ( - 0.1 ( {e}^{V} - 41 ) ) ] for V > ln ( 41 ) \\ {B}_{N} ( V ) = ln ( 0.125 ) + 0.0125 ( - {e}^{V} + 31 ) \\ {A}_{M} ( V ) = ln ( 0.1 ) + ( ln ( 56 V ) - [ ( 0.1 ( 56 - {e}^{V} ) ) ln ( 1 ) ] for V < ln ( 56 ) \\ ln ( 0.1 ) + ( V ln ( 56 ) ) - [ ln ( 1 ) ( - 0.1 ( {e}^{V} - 56 ) ] for V > ln ( 56 ) \\ {B}_{M} ( V ) = ln ( 4 ) + 0.0556 ( - {e}^{V} + 31 ) \\ {A}_{H} ( V ) = ln ( 0.07 ) + 0.05 ( - {e}^{V} + 31 ) \\ {B}_{H} ( V ) = - [ ( 0.1 ( - {e}^{V} + 61 ) ) 0 ]$$

$$\text{?} \text{indicates text missing or illegible when filed}$$

Values of Equation 5 are exponential logarithm values, and may be represented by uppercase letters. In the process of converting Equation 4 into Equation 5, the characteristic values of the HHM described in relation to Equation 4, for example, potassium conductance g_{K} per unit area, sodium conductance g_{Na} per unit area, leakage conductance g_{L} per unit area, potassium reversal potential v_{K}, sodium reversal potential v_{Na}, and leakage reversal potential v_{L} may be reflected as approximate values. Also, multiplications and divisions of real numbers may be changed to additions and subtractions of logarithm domain.

The operator ( [symbol] ) may be a Jacobian addition or a Jacobian adder. The Jacobian addition ( [symbol] ) may include computing an exponential logarithm of the sum of exponential powers with respect to the values of the inputs of the Jacobian adder ( [symbol] ). The Jacobian addition ( [symbol] ) may be defined by Equation 6.

$$C = A B = ln ( {e}^{A} + {e}^{B} ) \\ C = ln ( c ) , B = ln ( b ) , A = ln ( a ) \\ ln ( c ) = ln ( a + b ) \qquad [ Equation 6 ]$$

The operator ( [symbol] ) may be a Jacobian subtraction or a Jacobian subtractor. The Jacobian subtraction ( [symbol] ) may include calculating an exponential logarithm value obtained by subtracting an exponential power of the value of the second input from an exponential power of the value of the first input when the value of the first input of the Jacobian subtractor ( [symbol] ) is greater than the value of the second input, calculating an exponential logarithm value obtained by subtracting the exponential power of the value of the first input from the exponential power of the value of the second input when the value of the first input of the Jacobian subtractor ( [symbol] ) is not greater than the value of the second input, calculating a positive sign when the value of the first input of the Jacobian subtractor ( [symbol] ) is equal to or greater than the value of the second input, and calculating a negative sign when the value of the first input of the Jacobian subtractor ( [symbol] ) is less than the value of the second input. The Jacobian subtraction ( [symbol] ) may be defined by Equation 7.

D=A [symbol] B=D_{S}D_{M}

D_{S}=+1,D_{M}=ln(e^{A}−e^{B})( [symbol] ,A>B [symbol] A≥B)

D_{S}=−1,D_{M}=ln(e^{B}−e^{A})( [symbol] ,A<B [symbol] A≤B)

D=ln(d),B=ln(b),A=ln(a)

ln(d)=ln(a−b) [Equation 7]

The logarithm-based neuron calculation circuit 310 may be implemented with reduced computational complexity based on Equation 5.

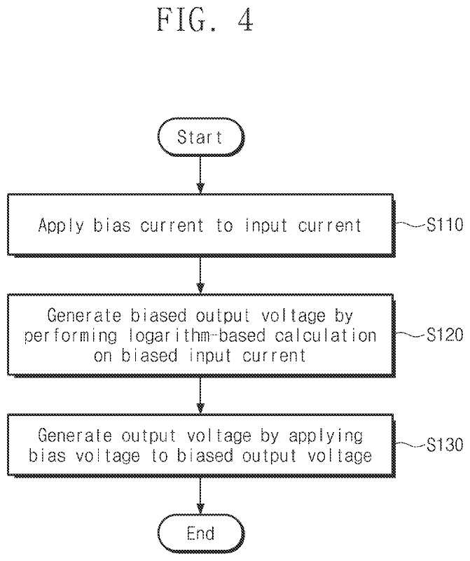

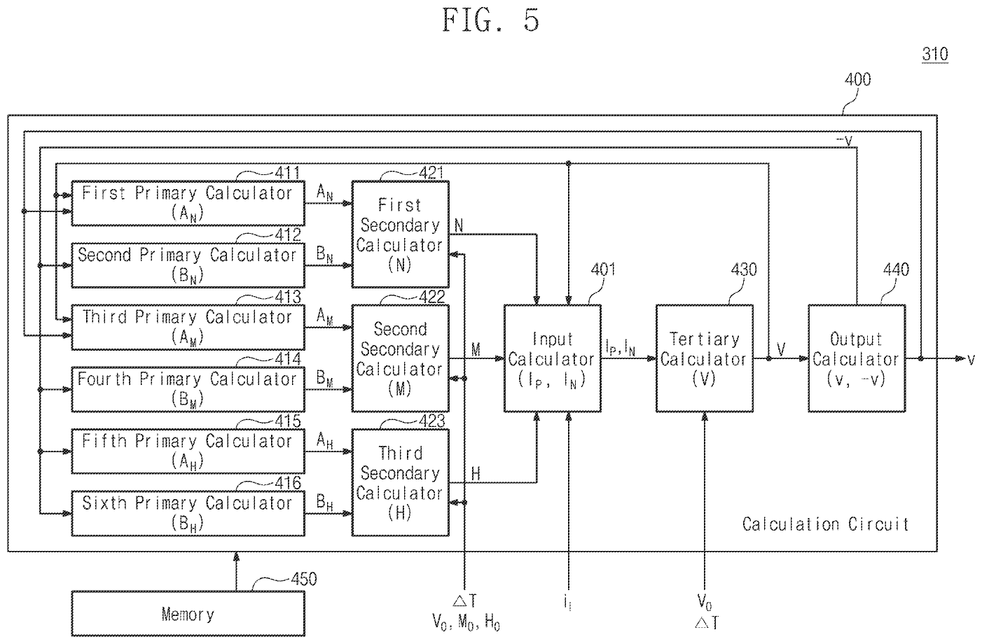

FIG. 4 illustrates an example of an operation method of the neuron circuit 300. Referring to FIGS. 3 and 4, in operation Sl10, the first bias circuit 320 may generate the biased input current i_{I} by applying the bias current I_{B} to the input current ii.

In operation S120, the logarithm-based neuron calculation circuit 310 may calculate an exponential logarithm value (e.g., an input logarithm value) of a value (e.g., the value of the amount of current) of the biased input current i_{I}, may calculate an exponential logarithm value of a value of a voltage (e.g., a voltage level) corresponding to a biased spike signal based on the exponential logarithm value of the biased input current i_{I}, and may output the biased output voltage ‘v’ by calculating an exponential power of an exponential logarithm value with respect to a value of a voltage corresponding to the biased spike signal. The output voltage ‘v’ may be a voltage corresponding to the biased spike signal.

In operation S130, the second bias circuit 330 may apply the bias voltage v_{B} to the output voltage ‘v’, for example, may subtract the bias voltage v_{B} from the output voltage ‘v’ to generate an output voltage ‘vo’. The output voltage ‘vo’ may be a voltage corresponding to the spike signal.

FIG. 5 illustrates an example of the logarithm-based neuron calculation circuit 310. Referring to FIG. 5 and Equation 5, the logarithm-based neuron calculation circuit 310 may include a calculation circuit 400 and a memory 450. The calculation circuit 400 may calculate the biased output voltage ‘v’ from the biased input current i_{I}. The memory 450 may store various values necessary for the calculation process of the calculation circuit 400 and may provide the stored values to the calculation circuit 400.

The calculation circuit 400 may include first to sixth primary calculators 411 to 416, first to third secondary calculators 421 to 423, an input calculator 401, a tertiary calculator 430, and an output calculator 440.

The first primary calculator 411 may generate a first parameter A_{N} based on an exponential logarithm value ‘V’ of a biased output voltage of a previous cycle and an inversion value ‘−v’ of the biased output voltage of the previous cycle.

The second primary calculator 412 may generate a second parameter B_{N} based on the inversion value ‘−v’ of the biased output voltage of the previous cycle.

The third primary calculator 413 may generate a third parameter A_{M} based on the exponential logarithm value ‘V’ of the biased output voltage of the previous cycle and the inversion value ‘−v’ of the biased output voltage of the previous cycle.

The fourth primary calculator 414 may generate a fourth parameter B_{M} based on the inversion value ‘−v’ of the biased output voltage of the previous cycle.

The fifth primary calculator 415 may generate a fifth parameter A_{H} based on the inversion value ‘−v’ of the biased output voltage of the previous cycle.

The sixth primary calculator 416 may generate a sixth parameter B_{H} based on the inversion value ‘−v’ of the biased output voltage of the previous cycle.

The first secondary calculator 421 may include a first parameter input to which the first parameter A_{N} is input, a second parameter input to which the second parameter B_{N} is input, and a parameter output to which a seventh parameter N is output. The first secondary calculator 421 may calculate the seventh parameter N of a current cycle based on the first parameter A_{N}, the second parameter B_{N}, an initial value N₀ of the seventh parameter, and an exponential logarithm value ΔT of a time difference between the previous cycle and the current cycle.

The second secondary calculator 422 may include a first parameter input to which the third parameter A_{M} is input, a second parameter input to which the fourth parameter B_{M} is input, and a parameter output to which an eighth parameter M is output. The second secondary calculator 422 may calculate the eighth parameter M of the current cycle based on the third parameter A_{M}, the fourth parameter B_{M}, an initial value M₀ of the eighth parameter, and the exponential logarithm value ΔT of the time difference.

The third secondary calculator 423 may include a first parameter input to which the fifth parameter A_{H} is input, a second parameter input to which the sixth parameter B_{H} is input, and a parameter output to which a ninth parameter H is output. The third secondary calculator 423 may calculate the ninth parameter H of the current cycle based on the fifth parameter A_{H}, the sixth parameter B_{H}, an initial value H₀ of the ninth parameter, and the exponential logarithm value ΔT of the time difference.

The input calculator 401 may generate a tenth parameter I_{P} and an eleventh parameter I_{N} based on the seventh to ninth parameters N, M, and H, the exponential logarithm value ‘V’ of the biased output voltage of the previous cycle, and the biased input current I_{B}.

The tertiary calculator 430 may generate the exponential logarithm value ‘V’ (or V(t+Δt) in Equation 5) of the biased output voltage of the current cycle based on the tenth parameter I_{P}, the eleventh parameter I_{N}, the exponential logarithm value V₀ of the initial value of the biased output voltage, and the exponential logarithm value ΔT of the time difference.

The output calculator 440 may generate the biased output voltage ‘v’ of the current cycle and the inversion value ‘−v’ of the biased output voltage of the current cycle based on the exponential logarithm value ‘V’ (or V(t+Δt) in Equation 5) of the biased output voltage of the current cycle. The ‘biased output voltage of the current cycle’ may be represented as ‘v(t+Δt)’. The ‘inversion value of the biased output voltage of the current cycle’ may be represented as ‘−v(t+Δt)’.

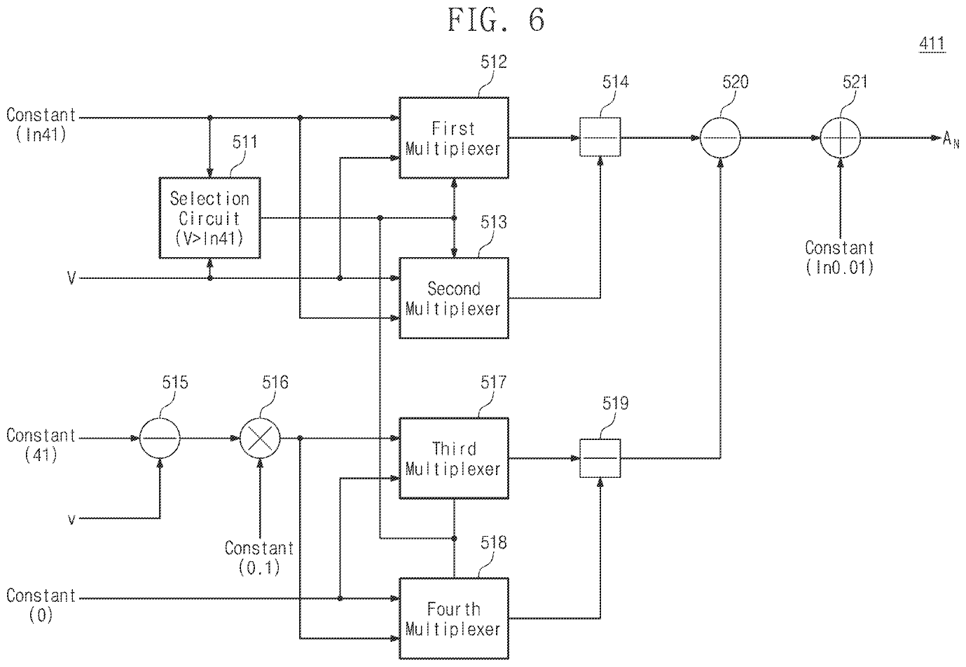

FIG. 6 illustrates an example of the first primary calculator 411. Referring to FIGS. 5 and 6, the first primary calculator 411 may include a selection circuit 511, a first multiplexer 512, a second multiplexer 513, a first Jacobian subtractor 514, a first subtractor 515, a multiplier 516, a third multiplexer 517, a fourth multiplexer 518, a second Jacobian subtractor 519, a second subtractor 520, and an adder 521.

The selection circuit 511 may receive the exponential logarithm value ‘V’ of the biased output voltage of the previous cycle and a value of ‘ln 41’. The value of ‘ln 41’ is a constant and may be provided from the memory 450. Accordingly, the value of ‘ln 41’ may not increase the amount of computation or the complexity of computation of the calculation circuit 400. The value provided from the memory 450 may be a value obtained by rounding down, rounding up, or rounding the result value of ‘ln 41’ to a specific digit.

The selection circuit 511 may control the first to fourth multiplexers 512, 513, 517, and 518 such that first inputs are connected to outputs when the exponential logarithm value ‘V’ of the biased output voltage of the previous cycle is greater (or equal to or greater) than a value of about ‘ln 41’, and second inputs are connected to outputs when the exponential logarithm value ‘V’ of the biased output voltage of the previous cycle is not greater than (or less than) the value of about ‘ln 41’.

The first multiplexer 512 may include a first input to which the value of about ‘ln 41’ is input and a second input to which the exponential logarithm value ‘V’ of the biased output voltage of the previous cycle is input. According to a control of the selection circuit 511, the first multiplexer 512 may transfer a value of the first input or a value of the second input as an output.

The second multiplexer 513 may include a first input to which the exponential logarithm value ‘V’ of the biased output voltage of the previous cycle is input and a second input to which the value of about ‘ln 41’ is input. According to a control of the selection circuit 511, the second multiplexer 513 may transfer a value of the first input or a value of the second input as an output.

The first Jacobian subtractor 514 may include a first input to which an output of the first multiplexer 512 is input and a second input to which an output of the second multiplexer 513 is input. The first Jacobian subtractor 514 may perform a Jacobian subtraction on the value of the first input and the value of the second input to output the result.

The first subtractor 515 may subtract the value of the biased output voltage ‘v’ from the value of about ‘41’ and may output the subtracted value. The value of ‘41’ is a constant and may be provided from the memory 450. The value provided from the memory 450 may be a value obtained by rounding down, rounding up, or rounding the value of ‘ln 41’ to a specific digit.

The multiplier 516 may multiply an output of the first subtractor 515 by a value of about ‘0.1’ and may output the multiplied result. The value of ‘0.1’ is a constant and may be provided from the memory 450. The value provided from the memory 450 may be a value obtained by rounding down, rounding up, or rounding the value of ‘0.1’ to a specific digit.

The third multiplexer 517 may include a first input to which an output of the multiplier 516 is input and a second input to which a value of about ‘0’ is input. The value of ‘0’ is a constant and may be provided from the memory 450. According to the control of the selection circuit 511, the third multiplexer 517 may transfer a value of the first input or a value of the second input as an output.

The fourth multiplexer 518 may include a first input to which a value of about ‘0’ is input and a second input to which an output of the multiplier 516 is input. According to the control of the selection circuit 511, the fourth multiplexer 518 may transfer a value of the first input or a value of the second input as an output.

The second Jacobian subtractor 519 may include a first input to which an output of the third multiplexer 517 is input and a second input to which an output of the fourth multiplexer 518 is input. The second Jacobian subtractor 519 may perform the Jacobian subtraction on the value of the first input and the value of the second input to output the result.

The second subtractor 520 may subtract an output of the second Jacobian subtractor 519 from an output of the first Jacobian subtractor 514, and may output the subtracted result.

The adder 521 may add a value of about ‘ln 0.01’ to an output of the second subtractor 520 and may output the added result as the first parameter A_{N}. The value of ‘ln 0.01’ is a constant and may be provided from the memory 450. The value provided from the memory 450 may be a value obtained by rounding down, rounding up, or rounding the result value of ‘ln 0.01’ to a specific digit.

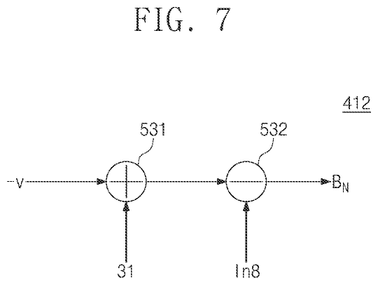

FIG. 7 illustrates an example of the second primary calculator 412. FIGS. 5 and 7, the second primary calculator 412 may include an adder 531 that adds a value of about ‘31’ to the inversion value ‘−v’ of the biased output voltage of the previous cycle. The value of ‘31’ is a constant and may be provided from the memory 450. The value provided from the memory 450 may be a value obtained by rounding down, rounding up, or rounding the value of ‘31’ to a specific digit.

The second primary calculator 412 may further include a subtractor that subtracts a value of about ‘ln 8’ from the output of the adder 531 and outputs the subtracted result as the second parameter B_{N}. The value of ‘ln 8’ is a constant and may be provided from the memory 450. The value provided from the memory 450 may be a value obtained by rounding down, rounding up, or rounding the result value of ‘ln 8’ to a specific digit.

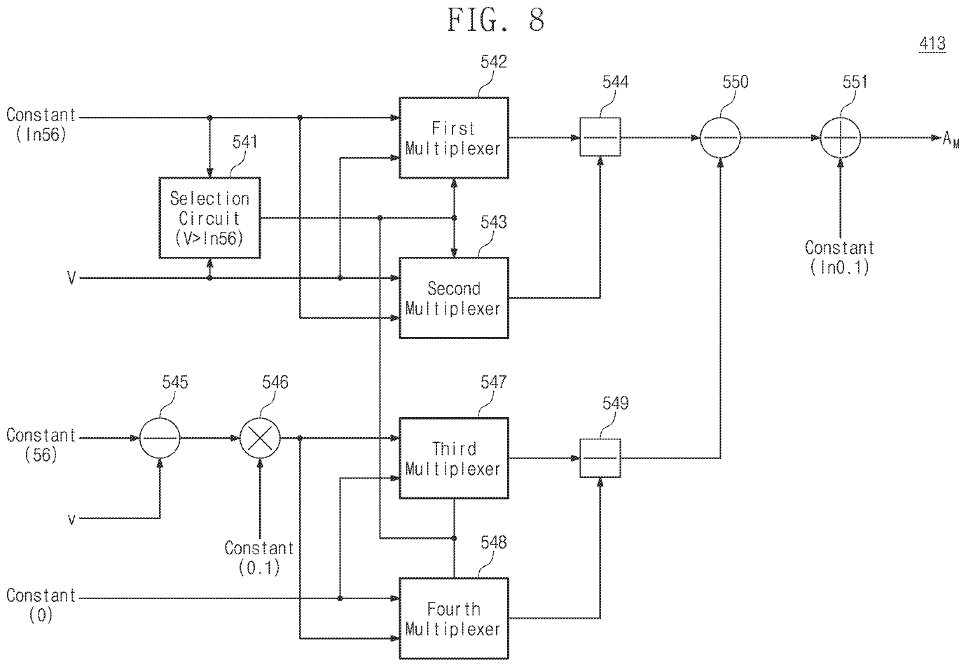

FIG. 8 illustrates an example of the third primary calculator 413. Referring to FIGS. 5 and 8, the third primary calculator 413 may include a selection circuit 541, a first multiplexer 542, a second multiplexer 543, a first Jacobian subtractor 544, a first subtractor 545, a multiplier 546, a third multiplexer 547, a fourth multiplexer 548, a second Jacobian subtractor 549, a second subtractor 550, and an adder 551.

The selection circuit 541 may receive the exponential logarithm value ‘V’ of the biased output voltage of the previous cycle and a value of ‘ln 56’. The value of ‘ln 56’ is a constant and may be provided from the memory 450. The value provided from the memory 450 may be a value obtained by rounding down, rounding up, or rounding the result value of ‘ln 56’ to a specific digit.

The selection circuit 541 may control the first to fourth multiplexers 542, 543, 547, and 548 such that first inputs are connected to outputs when the exponential logarithm value ‘V’ of the biased output voltage of the previous cycle is greater (or equal to or greater) than a value of about ‘ln 56’, and second inputs are connected to outputs when the exponential logarithm value ‘V’ of the biased output voltage of the previous cycle is not greater than (or less than) the value of about ‘ln 56’.

The first multiplexer 542 may include a first input to which the value of about ‘ln 56’ is input and a second input to which the exponential logarithm value ‘V’ of the biased output voltage of the previous cycle is input. According to a control of the selection circuit 541, the first multiplexer 542 may transfer a value of the first input or a value of the second input as an output.

The second multiplexer 543 may include a first input to which the exponential logarithm value ‘V’ of the biased output voltage of the previous cycle is input and a second input to which the value of about ‘ln 56’ is input. According to a control of the selection circuit 541, the first multiplexer 542 may transfer a value of the first input or a value of the second input as an output.

The first Jacobian subtractor 544 may include a first input to which an output of the first multiplexer 542 is input and a second input to which an output of the second multiplexer 543 is input. The first Jacobian subtractor 544 may perform a Jacobian subtraction on the value of the first input and the value of the second input to output the result.

The first subtractor 545 may subtract the value of the biased output voltage from a value of about ‘56’. The value of ‘56’ is a constant and may be provided from the memory 450. The value provided from the memory 450 may be a value obtained by rounding down, rounding up, or rounding the value of ‘56’ to a specific digit.

The multiplier 546 may multiply an output of the first subtractor 545 by a value of about ‘0.1’ and may output the multiplied result. The value of ‘0.1’ is a constant and may be provided from the memory 450. The value provided from the memory 450 may be a value obtained by rounding down, rounding up, or rounding the value of ‘0.1’ to a specific digit.

The third multiplexer 547 may include a first input to which an output of the multiplier 546 is input and a second input to which a value of about ‘0’ is input. The value of ‘0’ is a constant and may be provided from the memory 450. According to the control of the selection circuit 541, the third multiplexer 547 may transfer a value of the first input or a value of the second input as an output.

The fourth multiplexer 548 may include a first input to which a value of about ‘0’ is input and a second input to which an output of the multiplier 546 is input. According to the control of the selection circuit 541, the fourth multiplexer 548 may transfer a value of the first input or a value of the second input as an output.

The second Jacobian subtractor 549 may include a first input to which an output of the third multiplexer 547 is input and a second input to which an output of the fourth multiplexer 548 is input. The second Jacobian subtractor 549 may perform a Jacobian subtraction on the value of the first input and the value of the second input to output the result.

The second subtractor 550 may subtract an output of the second Jacobian subtractor 549 from an output of the first Jacobian subtractor 544, and may output the subtracted result.

The adder 551 may add a value of about ‘ln 0.1’ to an output of the second subtractor 550 and may output the added result as the third parameter A_{M}. The value of ‘ln 0.1’ is a constant and may be provided from the memory 450. The value provided from the memory 450 may be a value obtained by rounding down, rounding up, or rounding the result value of ‘ln 0.1’ to a specific digit.

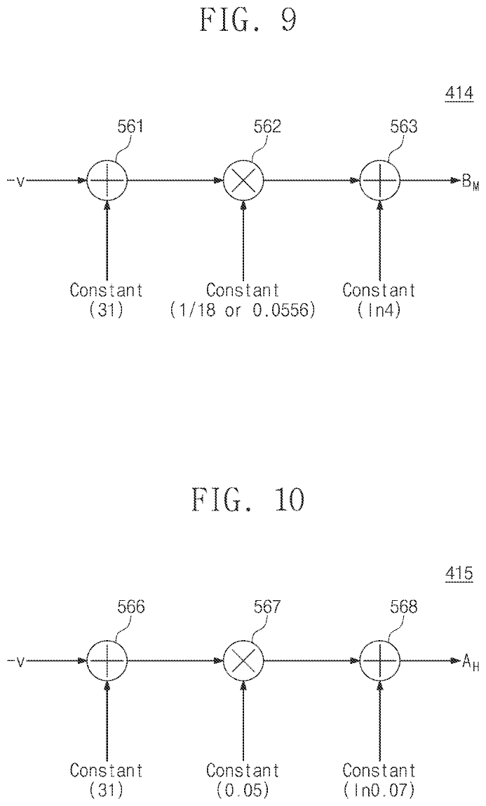

FIG. 9 illustrates an example of the fourth primary calculator 414. Referring to FIGS. 5 and 9, the fourth primary calculator 414 may include a first adder 561, a multiplier 562, and a second adder 563.

The first adder 561 may add a value of about ‘31’ to the inversion value ‘−v’ of the biased output voltage of the previous cycle. The value of ‘31’ is a constant and may be provided from the memory 450. The value provided from the memory 450 may be a value obtained by rounding down, rounding up, or rounding the value of ‘31’ to a specific digit.

The multiplier 562 may multiply an output of the first adder 561 by a value of about ‘ 1/18’ or about ‘0.0556’ to output the multiplied result. The value of about ‘ 1/18’ or about ‘0.0556’ is a constant and may be provided from the memory 450. The value provided from the memory 450 may be a value obtained by rounding down, rounding up, or rounding a value of about ‘ 1/18’ or about ‘0.0556’ to a specific digit.

The second adder 563 may add a value of about ‘ln 4’ to an output of the multiplier 562 and may output the added result as the fourth parameter B_{M}. The value of ‘ln 4’ is a constant and may be provided from the memory 450. The value provided from the memory 450 may be a value obtained by rounding down, rounding up, or rounding the result value of ‘ln 4’ to a specific digit.

FIG. 10 illustrates an example of the fifth primary calculator 415. Referring to FIGS. 5 and 10, the fifth primary calculator 415 may include a first adder 566, a multiplier 567, and a second adder 568.

The first adder 566 may add a value of about ‘31’ to the inversion value ‘−v’ of the biased output voltage of the previous cycle. The value of ‘31’ is a constant and may be provided from the memory 450. The value provided from the memory 450 may be a value obtained by rounding down, rounding up, or rounding the value of ‘31’ to a specific digit.

The multiplier 567 may multiply an output of the first adder 566 by a value of about ‘0.05’ and may output the multiplied result. The value of ‘0.05’ is a constant and may be provided from the memory 450. The value provided from the memory 450 may be a value obtained by rounding down, rounding up, or rounding the value of ‘0.05’ to a specific digit.

The second adder 568 may add a value of about ‘ln 0.07’ to an output of the multiplier 567 and may output the added result as the fifth parameter A_{H}. The value of ‘ln 0.07’ is a constant and may be provided from the memory 450. The value provided from the memory 450 may be a value obtained by rounding down, rounding up, or rounding the result value of ‘ln 0.07’ to a specific digit.

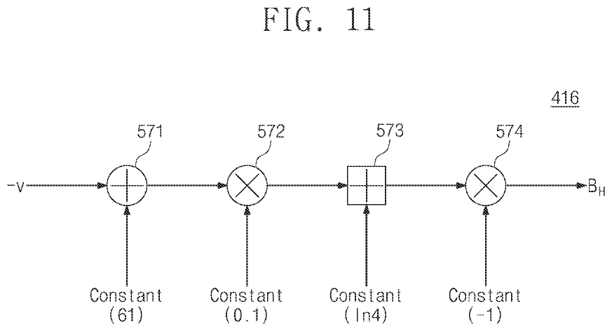

FIG. 11 is a diagram illustrating an example of the sixth primary calculator 416. Referring to FIGS. 5 and 11, the sixth primary calculator 416 may include an adder 571, a multiplier 572, a Jacobian adder 573, and a second multiplier 574.

The adder 571 may add a value of about ‘61’ to the inversion value ‘-v’ of the biased output voltage of the previous cycle. The value of ‘61’ is a constant and may be provided from the memory 450. The value provided from the memory 450 may be a value obtained by rounding down, rounding up, or rounding the value of ‘61’ to a specific digit.

The multiplier 572 may multiply an output of the adder 571 by a value of about ‘0.1’ and may output the multiplied result. The value of ‘0.1’ is a constant and may be provided from the memory 450. The value provided from the memory 450 may be a value obtained by rounding down, rounding up, or rounding the value of ‘0.1’ to a specific digit.

The Jacobian adder 573 may include a first input to which an output of the multiplier 572 is input and a second input to which a value of about ‘ln 4’ is input. The value of ‘ln 4’ is a constant and may be provided from the memory 450. The value provided from the memory 450 may be a value obtained by rounding down, rounding up, or rounding the result value of ‘ln 4’ to a specific digit. The Jacobian adder 573 may perform a Jacobian addition on the value of the first input and the value of the second input to output the added result.

The second multiplier 574 may multiply an output of the Jacobian adder 573 by a value of about ‘−1’ and output the multiplied result as the sixth parameter B_{H}. The value of ‘−1’ is a constant and may be provided from the memory 450. The value provided from the memory 450 may be a value obtained by rounding down, rounding up, or rounding the value of ‘−1’ to a specific digit.

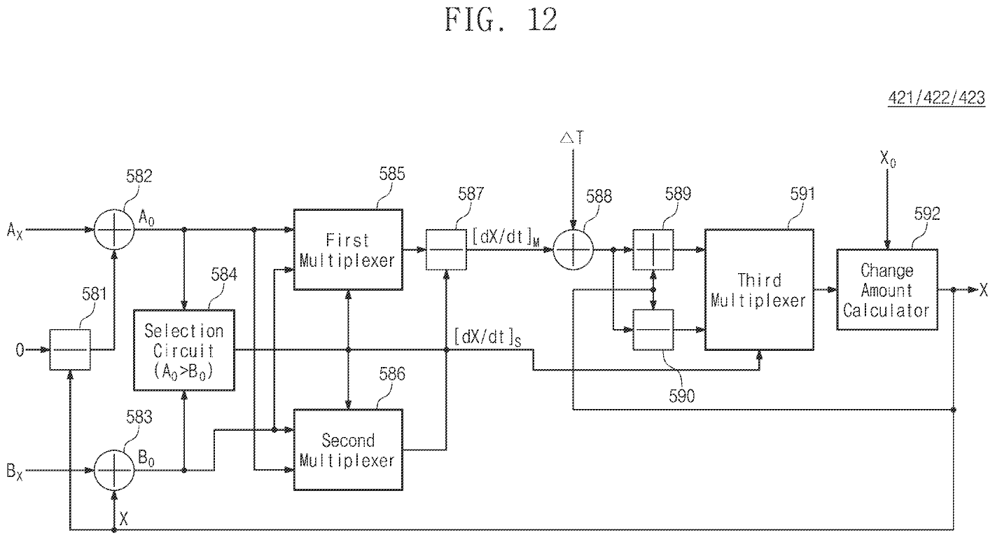

FIG. 12 illustrates an example of the secondary calculator 421, 422, or 423 of any one of the first to third secondary calculators 421, 422, and 423. The first to third secondary calculators 421, 422, and 423 may have the same structures.

Referring to FIGS. 5 and 12, the secondary calculator 421, 422, or 423 may include a first Jacobian subtractor 581, a first adder 582, a second adder 583, a selection circuit 584, a first multiplexer 585, a second multiplexer 586, a second Jacobian subtractor 587, a third adder 588, a Jacobian adder 589, a third Jacobian subtractor 590, a third multiplexer 591, and a change amount calculator 592.

The first Jacobian subtractor 581 may include a first input to which a value of ‘0’ is input and a second input to which a value of the parameter output X (here, X is one of N, M, and H) of the previous cycle of the secondary calculator 421, 422, or 423 is input, and may perform a Jacobian subtraction on the value of the first input and the value of the second input. The value of ‘0’ is a constant and may be provided from the memory 450.

The first adder 582 may add a value A_{X} (where X is one of N, M and H) of the first parameter input of the secondary calculator 421, 422, or 423 and the output of the first Jacobian subtractor 581 to output an output A₀.

The second adder 583 may add a value B_{X} (where X is one of N, M and H) of the second parameter input of the secondary calculator 421, 422, or 423 and the value of the parameter output X (where X is one of N, M, and H) of the previous cycle of the secondary calculator 421, 422, or 423 to output an output B₀.

The selection circuit 584 may receive the output A₀ of the first adder 582 and the output B₀ of the second adder 583. The selection circuit 584 may allow the first to third multiplexers 585, 586, and 591 to output the values of the first inputs when the output A₀ of the first adder 582 is greater than (or greater than or equal to) the output B₀ of the second adder 583, and may allow the first to third multiplexers 585, 586, and 591 to output the values of the second inputs when the output A₀ of the first adder 582 is not greater than (or less than) the output B₀ of the second adder 583. The output of the selection circuit 584 may correspond to a sign [dX/dt]s of an instantaneous change amount dX/dt of any one ‘X’ of the seventh to ninth parameters N, M, and H.

The first multiplexer 585 may include a first input to which the output A₀ of the first adder 582 is input and a second input to which the output B₀ of the second adder 583 is input. According to the control of the selection circuit 584, the first multiplexer 585 may output one of the value of the first input and the value of the second input.

The second multiplexer 586 may include a first input to which the output B₀ of the second adder 583 is input and a second input to which the output A₀ of the first adder 582 is input According to the control of the selection circuit 584, the second multiplexer 586 may output one of the value of the first input and the value of the second input.

The second Jacobian subtractor 587 may include a first input to which an output of the first multiplexer 585 is input and a second input to which an output of the second multiplexer 586 is input. The second Jacobian subtractor 587 may perform a Jacobian subtraction on the value of the first input and the value of the second input to output the result. The output of the second Jacobian subtractor 587 may correspond to a magnitude [dX/dt]_{M} of an instantaneous change amount dX/dt of any one (X) of the seventh to ninth parameters N, M, and H.

The third adder 588 may add the exponential logarithm value ΔT of the time difference between the previous cycle and the current cycle to the output [dX/dt]_{M} of the second Jacobian subtractor 587 to output the added result. The exponential logarithm value ΔT of the time difference may be a constant or a variable, and may be provided from the memory 450. The value of the exponential logarithm value ΔT of the time difference provided from the memory 450 may be rounded up, rounded down, or rounded to a specific digit.

The Jacobian adder 589 may perform the Jacobian addition on the output of the third adder 588 and the value X of the parameter output of the previous cycle to output the result.

The third Jacobian subtractor 590 may include a first input to which the output of the third adder 588 is input and a second input to which the value X of the parameter output of the previous cycle is input. The third Jacobian subtractor 590 may perform a Jacobian subtraction on the value of the first input and the value of the second input to output the result.

The third multiplexer 591 may include a first input to which the output of the Jacobian adder 589 is input and a second input to which the output of the third Jacobian subtractor 590 is input According to the control of the selection circuit 584, the third multiplexer 591 may output one of the value of the first input and the value of the second input.

The change amount calculator 592 may calculate the amount of change corresponding to the exponential logarithm value ΔT of the time difference, based on the output of the third multiplexer 591 and the corresponding initial value X₀ among initial values N₀, M₀, and H₀ of the seventh to ninth parameters N, M, and H. The initial value X₀ may be a constant or a variable, and may be provided from the memory 450. The initial value X0 provided from the memory 450 may be a value rounded up, rounded down, or rounded to a specific digit. For example, the change amount calculator 592 may calculate the change amount based on the Euler equation (or Euler differential equation). The change amount calculator 592 may add the change amount to the initial value X₀ and may output the added result as a corresponding parameter X among the seventh to ninth parameters N, M, and H.

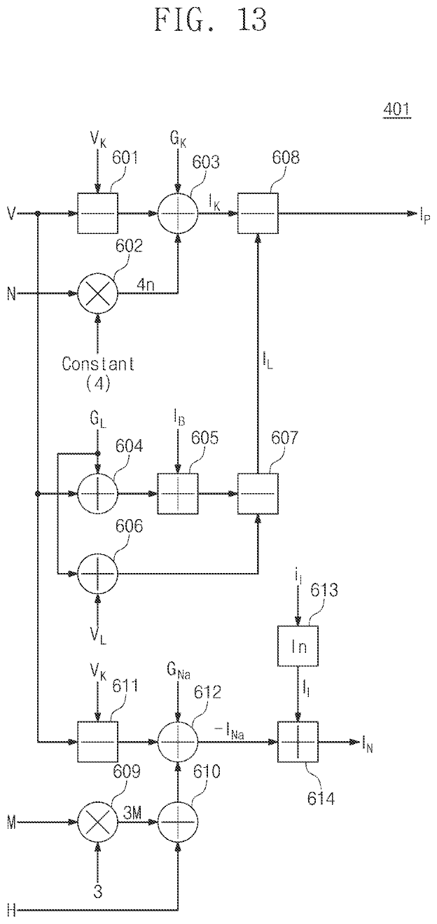

FIG. 13 illustrates an example of the input calculator 401. Referring to FIGS. 5 and 13, the input calculator 401 may include a first Jacobian subtractor 601, a first multiplier 602, a first adder 603, a second adder 604, a first Jacobian adder 605, a third adder 606, a second Jacobian subtractor 607, a third Jacobian subtractor 608, a fourth Jacobian subtractor 611, a fourth adder 610, a second multiplier 609, a fifth adder 612, an exponential logarithm calculator 613, and a second Jacobian adder 614.

The first Jacobian subtractor 601 may include a first input to which an exponential logarithm value ‘V’ of the biased output voltage of the previous cycle is input and a second input to which an exponential logarithm value V_{K} of the potassium reversal potential is input, and may perform a Jacobian subtraction on the value of the first input and the value of the second input to output the subtracted result. The exponential logarithm value V_{K} of the potassium reversal potential may be a constant (e.g., ln 19) and may be provided from memory 450. The value of the exponential logarithm value V_{K} of the potassium reversal potential provided from the memory 450 may be rounded up, rounded down, or rounded to a specific digit.

The first multiplier 602 may multiply the seventh parameter N and a value of ‘4’ to output the multiplied result. The value of ‘4’ is a constant and may be provided from the memory 450. The value provided from the memory 450 may be a value obtained by rounding down, rounding up, or rounding the value of ‘4’ to a specific digit.

The first adder 603 may sum an output of the first Jacobian subtractor 601, an output of the first multiplier 602, and the exponential logarithm value G_{K} of potassium conductance per area to output the added result. The exponential logarithm value G_{K} of the potassium conductance per area may be a constant (e.g., ln 36.0) and may be provided from the memory 450. The exponential logarithm value G_{K} of the potassium conductance per area provided from the memory 450 may be rounded up, rounded down, or rounded to a specific digit. The output of the first adder 603 may correspond to I_{K} of Equation 5.

The second adder 604 may sum of the exponential logarithm value ‘V’ of the biased output voltage of the previous cycle and the exponential logarithm value G_{L} of the leakage conductance per area. The exponential logarithm value G_{L} of the leakage conductance per area may be a constant (e.g., ln 0.3) and may be provided from the memory 450. The exponential logarithm value G_{L} of the leakage conductance per area provided from the memory 450 may be rounded up, rounded down, or rounded to a specific digit.

The first Jacobian adder 605 may perform the Jacobian addition on the output of the second adder 604 and the exponential logarithm I_{B} of the bias current value to output the added result. The exponential logarithm value I_{B} of the value of the bias current may be a constant (e.g., ln 10) and may be provided from the memory 450. The exponential logarithm value I_{B} of the value of the bias current provided from the memory 450 may be rounded up, rounded down, or rounded to a specific digit.

The third adder 606 may add the exponential logarithm value G_{L} of the leakage conductance per area and the exponential logarithm value V_{L} of the leakage reversal potential to output the added result. The exponential logarithm value V_{L} of the leakage reversal potential may be a constant (e.g., ln 41.613) and may be provided from memory 450. The exponential logarithm value V_{L} of the leakage reversal potential provided from the memory 450 may be rounded up, rounded down, or rounded to a specific digit.

The second Jacobian subtractor 607 may include a first input to which an output of the first Jacobian adder 605 is input and a second input to which an output of the third adder 606 is input. The second Jacobian subtractor 607 may perform the Jacobian subtraction on the value of the first input and the value of the second input to output the subtracted result. The output of the second Jacobian subtractor 607 may correspond to I_{L} of Equation 5.

The third Jacobian subtractor 608 may include a first input to which an output of the first adder 603 is input and a second input to which an output of the second Jacobian subtractor 607 is input. The third Jacobian subtractor 608 may perform the Jacobian subtraction on the value of the first input and the value of the second input to output the subtracted result as the tenth parameter I_{P}.

The second multiplier 609 may multiply the eighth parameter M by the value of ‘3’ to output the multiplied result. The value of ‘3’ is a constant and may be provided from the memory 450. The value provided from the memory 450 may be a value obtained by rounding down, rounding up, or rounding the value of ‘3’ to a specific digit.

The fourth adder 610 may add an output of the second multiplier 609 and the ninth parameter H to output the added result.

The fourth Jacobian subtractor 611 may include a first input to which the exponential logarithm value ‘V’ of the biased output voltage of the previous cycle is input and a second input to which the exponential logarithm value V_{K} of the potassium reversal potential is input. The fourth Jacobian subtractor 611 may perform the Jacobian subtraction on the value of the first input and the value of the second input to output the subtracted result.

The fifth adder 612 may add an output of the fourth Jacobian subtractor 611, the exponential logarithm value G_{Na} of the sodium conductance per area, and the output of the fourth adder 610. The exponential logarithm value G_{Na} of the sodium conductance per area may be a constant (e.g., ln 120.0) and may be provided from the memory 450. The exponential logarithm value G_{Na} of the sodium conductance per area provided from the memory 450 may be rounded up, rounded down, or rounded to a specific digit. The output of the fifth adder 612 may correspond to ‘−I_{Na}’ of Equation 5.

The exponential logarithm calculator 613 may calculate and output the exponential logarithm value I₁ of a value (e.g., the current amount value) of the biased input current i_{I}.

The second Jacobian adder 614 may perform Jacobian addition on the output of the fifth adder 612 and the output of the exponential logarithm calculator 613, and may output the added result as the eleventh parameter I_{N}.

As an example, the first Jacobian subtractor 601 and the fourth Jacobian subtractor 611 perform the same calculations. Accordingly, the first Jacobian subtractor 601 and the fourth Jacobian subtractor 611 may be integrated into one Jacobian subtractor. For example, the fourth Jacobian subtractor 611 is removed, and the output of the first Jacobian subtractor 601 may be provided to the fifth adder 612 instead of the output of the fourth Jacobian subtractor 611.

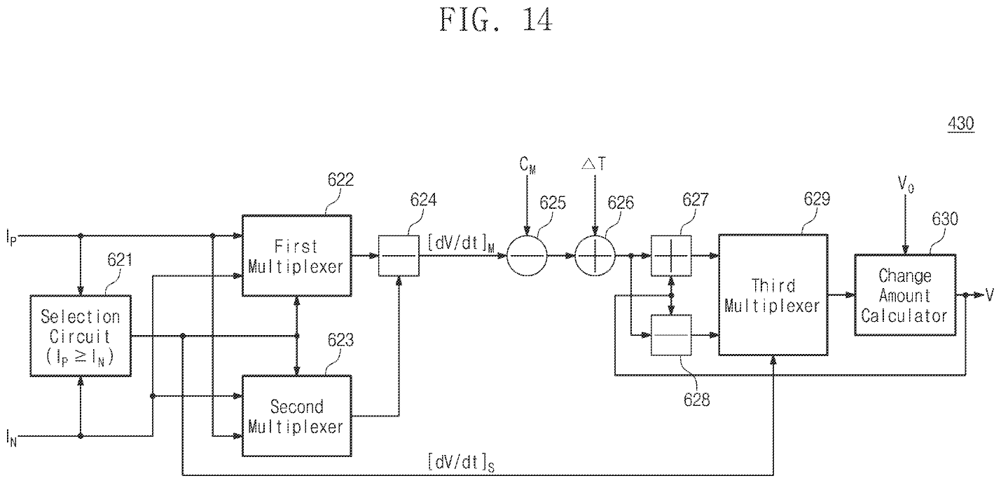

FIG. 14 illustrates an example of the tertiary calculator 430. Referring to FIGS. 5 and 14, the tertiary calculator 430 may include a selection circuit 621, a first multiplexer 622, a second multiplexer 623, a first Jacobian subtractor 624, a subtractor 625, an adder 626, a Jacobian adder 627, a second Jacobian subtractor 628, a third multiplexer 629, and a change amount calculator 630.

The selection circuit 621 may receive the tenth parameter I_{P} and the eleventh parameter I_{N}. The selection circuit 621 may control the first to third multiplexers 622, 623, and 629 such that values of the first inputs are output when the tenth parameter I_{P} is equal to or greater than (or greater than) the eleventh parameter I_{N}, and values of the second inputs are output when the tenth parameter I_{P} is less than (or equal to or less than) the eleventh parameter I_{N}. The output of the selection circuit 621 may correspond to the sign [dV/dt]s of the instantaneous change amount dV/dt of the biased output voltage ‘V’.

The first multiplexer 622 may include a first input to which the tenth parameter I_{P} is input and a second input to which the eleventh parameter I_{N} is input. According to the control of the selection circuit 621, the first multiplexer 622 may output one of the value of the first input and the value of the second input.

The second multiplexer 623 may include a first input to which the eleventh parameter I_{N} is input and a second input to which the tenth parameter I_{P} is input. According to the control of the selection circuit 621, the second multiplexer 623 may output one of the value of the first input and the value of the second input.

The first Jacobian subtractor 624 may include a first input to which an output of the first multiplexer 622 is input and a second input to which an output of the second multiplexer 623 is input. The first Jacobian subtractor 624 may perform a Jacobian subtraction on the value of the first input and the value of the second input to output the result. The output of the first Jacobian subtractor 624 may correspond to the magnitude [dV/dt]_{M} of the instantaneous change amount dV/dt of the biased output voltage ‘V’.

The subtractor 625 may subtract an exponential logarithm value C_{M} of the membrane capacitance per area from the output [dV/dt]_{M} of the first Jacobian subtractor and may output the subtracted result.

The adder 626 may add the exponential logarithm value ΔT of the time difference to the output of the subtractor 625 and may output the added result.

The Jacobian adder 627 may perform the Jacobian addition on the output of the adder 626 and the exponential logarithm value ‘V’ of the biased output voltage of the previous cycle to output the added result.

The second Jacobian subtractor 628 may include a first input to which an output of the adder 626 is input, and a second input to which the exponential logarithm value ‘V’ of the biased output voltage of the previous cycle is input. The second Jacobian subtractor 628 may perform a Jacobian subtraction on the value of the first input and the value of the second input to output the subtracted result.

The third multiplexer 629 may include a first input to which the output of the Jacobian adder 627 is input and a second input to which the output of the second Jacobian subtractor 628 is input. According to the control of the selection circuit 621, the third multiplexer 629 may output one of the value of the first input and the value of the second input.

The change amount calculator 630 may calculate the exponential logarithm value ‘V’ (or V(t+ΔT) in Equation 5) of the biased output voltage of the current cycle based on the output of the third multiplexer 629 and the exponential logarithm value V₀ of the initial value of the biased output voltage. The exponential logarithm value V₀ of the initial value of the biased output voltage may be a constant or a variable, and may be provided from the memory 450. The exponential logarithm value V₀ of the initial value of the biased output voltage provided from the memory 450 may be rounded up, rounded down, or rounded to a specific digit. For example, the change amount calculator 630 may calculate the change amount based on the Euler equation (or Euler differential equation).

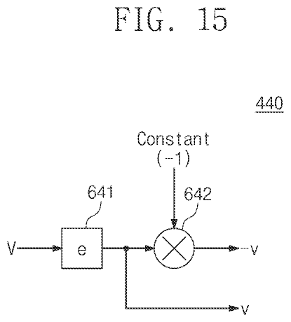

FIG. 15 illustrates an example of the output calculator 440. FIGS. 5 and 15, the output calculator 440 may include an exponential calculator 641 and a multiplier 642.

The exponential calculator 641 may calculate an exponential power of the exponential logarithm value of the biased output voltage of the current cycle and may output the calculated result as the biased output voltage ‘v’.

The multiplier 642 may multiply a value of the biased output voltage ‘v’ by a value of ‘−1’ and may output the multiplied result as the inversion value ‘−v’ of the biased output voltage.

In the above embodiments, components according to the present disclosure are described by using the terms “first”, “second”, “third”, and the like. However, the terms “first”, “second”, “third”, and the like may be used to distinguish components from each other and do not limit the present disclosure. For example, the terms “first”, “second”, “third”, and the like do not involve an order or a numerical meaning of any form.

In the above embodiments, components according to embodiments of the present disclosure are described by using blocks. The blocks may be implemented with various hardware devices, such as an integrated circuit, an application specific IC (ASIC), a field programmable gate array (FPGA), and a complex programmable logic device (CPLD), firmware driven in hardware devices, software such as an application, or a combination of a hardware device and software. In addition, the blocks may include circuits composed of semiconductor devices in the IC or circuits registered as an I_{P} (Intellectual Property).

According to an embodiment of the present disclosure, the neuron circuit performs calculations on a bias basis and on a logarithm basis. Accordingly, a neuron circuit with reduced computational complexity and a neural processor including the neuron circuits are provided.

The above description refers to embodiments for implementing the present disclosure. Embodiments in which a design is changed simply or which are easily changed may be included in the present disclosure as well as an embodiment described above. In addition, technologies that are easily changed and implemented by using the above embodiments may be included in the present disclosure. While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A neuron circuit comprising:
a first bias circuit configured to add a bias current to an input current to generate a biased input current;
a logarithm-based neuron calculation circuit configured to perform a logarithm calculation on an amount of current of the biased input current to generate an input logarithm value, and to generate a biased output voltage by performing a logarithm-based Hodgkin-Huxley model calculation based on the input logarithm value; and
a second bias circuit configured to add a bias voltage to the biased output voltage to generate an output voltage.

2. The neuron circuit of claim 1, wherein the bias current is set such that the biased input current corresponds to a positive value even when the input current corresponds to a negative value.

3. The neuron circuit of claim 1, wherein the bias current is about 10 uA.

4. The neuron circuit of claim 1, wherein the bias voltage is about 96 mV.

5. The neuron circuit of claim 1, wherein the logarithm-based neuron calculation circuit includes:
a first primary calculator configured to generate a first parameter based on an exponential logarithm value of the biased output voltage of a previous cycle and an inversion value of the biased output voltage of the previous cycle;
a second primary calculator configured to generate a second parameter based on the inversion value of the biased output voltage of the previous cycle;
a third primary calculator configured to generate a third parameter based on the exponential logarithm value of the biased output voltage of the previous cycle and the inversion value of the biased output voltage of the previous cycle;
a fourth primary calculator configured to generate a fourth parameter based on the inversion value of the biased output voltage of the previous cycle;
a fifth primary calculator configured to generate a fifth parameter based on the inversion value of the biased output voltage of the previous cycle; and
a sixth primary calculator configured to generate a sixth parameter based on the inversion value of the biased output voltage of the previous cycle.

6. The neuron circuit of claim 5, wherein the first primary calculator includes:
a first multiplexer including a first input to which a value of about ‘ln 41’ is input and a second input to which the exponential logarithm value of the biased output voltage of the previous cycle is input;
a second multiplexer including a first input to which the exponential logarithm value of the biased output voltage of the previous cycle is input and a second input to which the value of about ‘ln 41’ is input;
a first subtractor configured to subtract a value of the biased output voltage from a value of about ‘41’;
a multiplier configured to multiply an output of the first subtractor by a value of about ‘0.1’;
a third multiplexer including a first input to which an output of the multiplier is input and a second input to which a value of about ‘0’ is input;
a fourth multiplexer including a first input to which the value of about ‘0’ is input and a second input to which an output of the multiplier is input;
a selection circuit configured to control the first to fourth multiplexers such that first inputs are connected to outputs when the exponential logarithm value of the biased output voltage of the previous cycle is greater than the value of about ‘ln 41’, and second inputs are connected to the outputs when the exponential logarithm value of the biased output voltage of the previous cycle is not greater than the value of about ‘ln 41’;
a first Jacobian subtractor including a first input to which an output of the first multiplexer is input and a second input to which an output of the second multiplexer is input, and configured to perform a Jacobian subtraction on a value of the first input and a value of the second input;
a second Jacobian subtractor including a first input to which an output of the third multiplexer is input and a second input to which an output of the fourth multiplexer is input, and configured to perform the Jacobian subtraction on a value of the first input and a value of the second input;
a second subtractor configured to subtract an output of the second Jacobian subtractor from an output of the first Jacobian subtractor; and
an adder configured to add a value of about ‘ln 0.01’ to an output of the subtractor and to output the added result as the first parameter, and
wherein the Jacobian subtraction includes:
when the value of the first input of the first Jacobian subtractor or the second Jacobian subtractor is greater than the value of the second input, calculating an exponential logarithm of a value obtained by subtracting an exponential power of the value of the second input from an exponential power of the value of the first input;
when the value of the first input of the first Jacobian subtractor or the second Jacobian subtractor is not greater than the value of the second input, calculating an exponential logarithm of a value obtained by subtracting the exponential power of the value of the first input from the exponential power of the value of the second input;
when the value of the first input of the first Jacobian subtractor or the second Jacobian subtractor is equal to or greater than the value of the second input, calculating a positive sign, and
when the value of the first input of the first Jacobian subtractor or the second Jacobian subtractor is less than the value of the second input, calculating a negative sign.

7. The neuron circuit of claim 5, wherein the second primary calculator includes:
an adder configured to add a value of about ‘31’ to the inversion value of the biased output voltage of the previous cycle; and
a subtractor configured to subtract a value of about ‘ln 8’ from an output of the adder and to output the subtracted result as the second parameter.

8. The neuron circuit of claim 5, wherein the third primary calculator includes:
a first multiplexer including a first input to which a value of about ‘ln 56’ is input and a second input to which the exponential logarithm value of the biased output voltage of the previous cycle is input;
a second multiplexer including a first input to which the exponential logarithm value of the biased output voltage of the previous cycle is input and a second input to which the value of about ‘ln 56’ is input;
a first subtractor configured to subtract a value of the biased output voltage from a value of about ‘56’;
a multiplier configured to multiply the output of the first subtractor by a value of about ‘0.1’;
a third multiplexer including a first input to which an output of the multiplier is input and a second input to which a value of about ‘0’ is input;
a fourth multiplexer including a first input to which the value of about ‘0’ is input and a second input to which the output of the multiplier is input;
a selection circuit configured to control the first to fourth multiplexers such that first inputs are connected to outputs when the exponential logarithm value of the biased output voltage of the previous cycle is greater than a value of about ‘ln 56’, and second inputs are connected to the outputs when the exponential logarithm value of the biased output voltage of the previous cycle is not greater than the value of about ‘ln 56’;
a first Jacobian subtractor including a first input to which an output of the first multiplexer is input and a second input to which an output of the second multiplexer is input, and configured to perform a Jacobian subtraction on a value of the first input and a value of the second input;
a second Jacobian subtractor including a first input to which an output of the third multiplexer is input and a second input to which an output of the fourth multiplexer is input, and configured to perform the Jacobian subtraction on a value of the first input and a value of the second input;
a second subtractor configured to subtract an output of the second Jacobian subtractor from an output of the first Jacobian subtractor; and
an adder configured to add a value of about ‘ln 0.1’ to an output of the subtractor and to output the added result as the third parameter.

9. The neuron circuit of claim 5, wherein the fourth primary calculator includes:
a first adder configured to add a value of about ‘31’ to the inversion value of the biased output voltage of the previous cycle;
a multiplier configured to multiply the output of the first adder by a value of about ‘ 1/18’ or a value of about ‘0.0556’; and
a second adder configured to add a value of about ‘ln 4’ to an output of the multiplier and to output the added result as the fourth parameter.

10. The neuron circuit of claim 5, wherein the fifth primary calculator includes:
a first adder configured to add a value of about ‘31’ to the inversion value of the biased output voltage of the previous cycle;
a multiplier configured to multiply the output of the first adder by a value of about ‘0.05’; and
a second adder configured to add a value of about ‘ln 0.07’ to an output of the multiplier and to output the added result as the fifth parameter.

11. The neuron circuit of claim 5, wherein the sixth primary calculator includes:
a first adder configured to add a value of about ‘61’ to the inversion value of the biased output voltage of the previous cycle;
a first multiplier configured to multiply an output of the first adder by a value of about ‘0.1’;
a Jacobian adder including a first input to which an output of the first multiplexer is input and a second input to which a value of about ‘ln 4’ is input, and configured to perform a Jacobian addition on a value of the first input and a value of the second input; and
a second multiplier configured to multiply an output of the Jacobian adder by a value of about ‘−1’ and to output the multiplied result as the sixth parameter, and wherein the Jacobian addition includes calculating an exponential logarithm of a sum of an exponential power of the value of the first input and an exponential power of the value of the second input of the Jacobian adder.

12. The neuron circuit of claim 5, further comprising:
a first secondary calculator including a first parameter input to which the first parameter is input, a second parameter input to which the second parameter is input, and a parameter output to which a seventh parameter is output, and configured to calculate the seventh parameter of a current cycle, based on the first parameter, the second parameter, an initial value of the seventh parameter, and an exponential logarithm value of a time difference between the previous cycle and the current cycle;
a second secondary calculator including a first parameter input to which the third parameter is input, a second parameter input to which the fourth parameter is input, and a parameter output to which an eighth parameter is output, and configured to calculate the eighth parameter of the current cycle, based on the third parameter, the fourth parameter, an initial value of the eighth parameter, and the exponential logarithm value of the time difference; and
a third secondary calculator including a first parameter input to which the fifth parameter is input, a second parameter input to which the sixth parameter is input, and a parameter output to which a ninth parameter is output, and configured to calculate the ninth parameter of the current cycle, based on the fifth parameter, the sixth parameter, an initial value of the ninth parameter, and an exponential logarithm value of the time difference.

13. The neuron circuit of claim 12, wherein each of the first to third secondary calculators includes:
a first Jacobian subtractor including a first input to which a value of ‘0’ is input and a second input to which a value of the parameter output of the previous cycle is input, and configured to perform a Jacobian subtraction on a value of the first input and a value of the second input;
a first adder configured to add a value of the first parameter input and an output of the first Jacobian subtractor;
a second adder configured to add a value of the second parameter input and a value of the parameter output of the previous cycle;
a first multiplexer including a first input to which an output of the first adder is input and a second input to which an output of the second adder is input;
a second multiplexer including a first input to which the output of the second adder is input and a second input to which the output of the first adder is input;
a second Jacobian subtractor including a first input to which an output of the first multiplexer is input and a second input to which an output of the second multiplexer is input, and configured to perform the Jacobian subtraction on a value of the first input and a value of the second input;
a third adder configured to add the exponential logarithm value of the time difference to an output of the second Jacobian subtractor;
a Jacobian adder configured to perform a Jacobian addition on an output of the third adder and a value of the parameter output of the previous cycle;
a third Jacobian subtractor including a first input to which an output of the third adder is input and a second input to which the value of the parameter output of the previous cycle is input, and configured to perform a third Jacobian subtraction on a value of the first input and a value of the second input;
a third multiplexer including a first input to which an output of the Jacobian adder is input and a second input to which an output of the third Jacobian subtractor is input;
a selection circuit configured to allow the first to third multiplexers to output values of first inputs when an output of the first adder is greater than an output of the second adder, and to allow the first to third multiplexers to output values of second inputs when the output of the first adder is not greater than the output of the second adder; and
a change amount calculator configured to calculate an amount of change corresponding to the exponential logarithm value of the time difference based on an output of the third multiplexer and a corresponding initial value among initial values of the seventh to ninth parameters, and to add the amount of change to the initial value and to output the added result as a corresponding parameter among the seventh to ninth parameters.

14. The neuron circuit of claim 12, further comprising:
an input calculator configured to generate a tenth parameter and an eleventh parameter based on the seventh to ninth parameters, the exponential logarithm value of the biased output voltage of the previous cycle, and the biased input current;
a tertiary calculator configured to generate an exponential logarithm value of the biased output voltage of the current cycle, based on the tenth parameter, the eleventh parameter, an exponential logarithm value of an initial value of the biased output voltage, and the exponential logarithm value of the time difference; and
an output calculator configured to generate the biased output voltage of the current cycle and an inversion value of the biased output voltage of the current cycle, based on the exponential logarithm value of the biased output voltage of the current cycle.

15. The neuron circuit of claim 14, wherein the input calculator includes:
a first Jacobian subtractor including a first input to which the exponential logarithm value of the biased output voltage of the previous cycle is input and a second input to which an exponential logarithm value of a potassium reversal potential is input, and configured to perform a Jacobian subtraction on a value of the first input and a value of the second input;
a first multiplier configured to multiply the seventh parameter by a value of ‘4’;
a first adder configured to add an output of the first Jacobian subtractor, an output of the first multiplier, and an exponential logarithm value of potassium conductance per area;
a second adder configured to add the exponential logarithm value of the biased output voltage of the previous cycle and an exponential logarithm value of leakage conductance per area;
a first Jacobian adder configured to perform a Jacobian addition on an output of the second adder and an exponential logarithm value of a value of the bias current;
a third adder configured to add the exponential logarithm value of the leakage conductance per area and an exponential logarithm value of a leakage reversal potential;
a second Jacobian subtractor including a first input to which an output of the first Jacobian adder is input and a second input to which an output of the third adder is input, and configured to perform the Jacobian subtraction on a value of the first input and a value of the second input and to output the performed result as the tenth parameter;
a third Jacobian subtractor including a first input to which an output of the first adder is input and a second input to which an output of the second Jacobian subtractor is input, and configured to perform the Jacobian subtraction on a value of the first input and a value of the second input;
a second multiplier configured to multiply the eighth parameter by a value of ‘3’;
a fourth adder configured to add an output of the second multiplier and the ninth parameter;
a fourth Jacobian subtractor including a first input to which the exponential logarithm value of the biased output voltage of the previous cycle is input and a second input to which the exponential logarithm value of the potassium reversal potential is input, and configured to perform the Jacobian subtraction on a value of the first input and a value of the second input;
a fifth adder configured to add an output of the fourth Jacobian subtractor, an exponential logarithm value of sodium conductance per area, and an output of the fourth adder;
an exponential logarithm calculator configured to calculate an exponential logarithm value of a value of the biased input current; and
a second Jacobian adder configured to perform the Jacobian addition on an output of the fifth adder and an output of the exponential logarithm calculator, and to output the added result as the eleventh parameter.

16. The neuron circuit of claim 14, wherein the tertiary calculator includes:
a first multiplexer including a first input to which the tenth parameter is input and a second input to which the eleventh parameter is input;
a second multiplexer including a first input to which the eleventh parameter is input and a second input to which the tenth parameter is input;
a first Jacobian subtractor including a first input to which an output of the first multiplexer is input and a second input to which an output of the second multiplexer is input, and configured to perform a Jacobian subtraction on a value of the first input and a value of the second input;
a subtractor configured to subtract an exponential logarithm value of a membrane capacitance per area from an output of the first Jacobian subtractor;
an adder configured to add the exponential logarithm value of the time difference to an output of the subtractor;
a Jacobian adder configured to perform a Jacobian addition on an output of the adder and the exponential logarithm value of the biased output voltage of the previous cycle;
a second Jacobian subtractor including a first input to which an output of the adder is input and a second input to which the exponential logarithm value of the biased output voltage of the previous cycle is input, and configured to perform a Jacobian subtraction on a value of the first input and a value of the second input;
a third multiplexer including a first input to which an output of the Jacobian adder is input and a second input to which an output of the second Jacobian subtractor is input;
a selection circuit configured to control the first to third multiplexer such that values of first inputs are output when the tenth parameter is greater than or equal to the eleventh parameter and values of second inputs are output when the tenth parameter is less than the eleventh parameter; and
a change amount calculator configured to calculate an exponential logarithm value of the biased output voltage of the current cycle, based on an output of the third multiplexer and an exponential logarithm value of an initial value of the biased output voltage.

17. The neuron circuit of claim 14, wherein the output calculator includes:
an exponential calculator configured to calculate an exponential power of an exponential logarithm value of the biased output voltage of the current cycle and to output the calculated result as the biased output voltage; and
a multiplier configured to multiply the value of the biased output voltage by a value of ‘−1’ and to output the multiplied result as the inversion value of the biased output voltage.

18. A neural processor comprising:
a plurality of neuron circuits, and
wherein the plurality of neuron circuits are configured to perform a spiking neural network (SNN) operation, and
wherein each of the plurality of neuron circuits includes:
a first bias circuit configured to add a bias current to an input current to generate a biased input current;
a logarithm-based neuron calculation circuit configured to perform a logarithm calculation on an amount of current of the biased input current to generate an input logarithm value, and to generate a biased output voltage by performing a logarithm-based Hodgkin-Huxley model calculation based on the input logarithm value; and
a second bias circuit configured to add a bias voltage to the biased output voltage to generate an output voltage.

19. The neural processor of claim 18, wherein the bias current is about 10 uA, and the bias voltage is about 96 mV.
